(19) United States
(12) Patent Application Publication
(10) Pub. No.: US 2013/0301787 A1
(43) Pub. Date: Nov. 14, 2013

(54) PRESSURIZED WATER REACTOR WITH REACTOR COLLANT PUMPS COMPRISING TURBO PUMPS DRIVEN BY EXTERNAL PUMPS

(71) Applicant: Babcock & Wilcox Power Generation Group, Inc., (US)

(72) Inventor: Robert T. FORTINO, Canton, OH (US)

(21) Appl. No.: 13/862,742

(22) Filed: Apr. 15, 2013

Related U.S. Application Data
(60) Provisional application No. 61/624,942, filed on Apr. 16, 2012.
(60) Provisional application No. 61/624,966, filed on Apr. 16, 2012.

(51) Int. Cl. G21C 15/25

(52) U.S. Cl. CPC G21C 15/25
USPC 376/392

(57) ABSTRACT

A pressurized water reactor (PWR) includes a pressure vessel containing a nuclear core comprising a fissile material immersed in primary coolant water. A reactor coolant pump (RCP) is configured to pump primary coolant water in the pressure vessel. The RCP includes a hydraulically driven turbo pump disposed in the pressure vessel. The turbo pump includes an impeller performing pumping of primary coolant water in the pressure vessel, and a hydraulically driven turbine mechanically coupled with the impeller to drive the impeller. The RCP may further include a hydraulic pump configured pump primary coolant water to generate hydraulic working fluid that drives the hydraulically driven turbine. The hydraulic pump may be a canned pump having a casing defining a portion of the pressure boundary of the pressure vessel. The casing includes electrical feedthroughs delivering electrical power to the hydraulic pump.

This application claims the benefit of U.S. Provisional Application No. 61/624,942 filed Apr. 16, 2012 and titled “PRESSURIZED WATER REACTOR WITH REACTOR COOLANT PUMPS COMPRISING TURBO PUMPS DRIVEN BY EXTERNAL PUMPS”. U.S. Provisional Application No. 61/624,942 filed Apr. 16, 2012 titled “PRESSURIZED WATER REACTOR WITH REACTOR COOLANT PUMPS COMPRISING TURBO PUMPS DRIVEN BY EXTERNAL PUMPS” is hereby incorporated by reference in its entirety into the specification of this application.

This application claims the benefit of U.S. Provisional Application No. 61/624,966 filed Apr. 16, 2012 and titled “COOLANT PUMP APPARATUSES AND METHODS OF USE FOR SMRS”. U.S. Provisional Application No. 61/624,966 filed Apr. 16, 2012 and titled “COOLANT PUMP APPARATUSES AND METHODS OF USE FOR SMRS” is hereby incorporated by reference in its entirety into the specification of this application.

### BACKGROUND

The following relates to the nuclear reactor arts, nuclear power generation arts, nuclear reactor hydrodynamic design arts, and related arts.

In nuclear reactor designs of the pressurized water reactor (PWR) type, a radioactive nuclear reactor core is immersed in primary coolant water at or near the bottom of a pressure vessel. The primary coolant is maintained in a compressed or subcooled liquid phase. In applications in which steam generation is desired, the primary coolant water is flowed out of the pressure vessel, into an external steam generator where it heats secondary coolant water flowing in a separate secondary coolant path, and back into the pressure vessel. Alternatively an internal steam generator is located inside the pressure vessel (sometimes called an “integral PWR” design), and the secondary coolant is flowed into the pressure vessel within a separate secondary coolant path in the internal steam generator. In either design, heated primary coolant water heats secondary coolant water in the steam generator to convert the secondary coolant water into steam. An advantage of the PWR design is that the steam comprises secondary coolant water that is not exposed to the radioactive reactor core.

In a typical PWR design configuration, the primary coolant flow circuit is defined by a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser and reverses direction to flow downward back toward the reactor core through a downcomer annulus defined between the pressure vessel and the central riser. This is a natural convection flow circuit that can, in principle, be driven by heat injection from the reactor core and cooling of the primary coolant as it flows upward and away from the reactor core. However, for higher power reactors it is advantageous or even necessary to supplement or supplant the natural convection with motive force provided by electromechanical reactor coolant pumps.

Most commercial PWR systems employ external steam generators. In such systems, the primary coolant water is pumped by an external pump connected with external piping running between the PWR pressure vessel and the external steam generator. This also provides motive force for circulating the primary coolant water within the pressure vessel, since the pumps drive the entire primary coolant flow circuit including the portion within the pressure vessel.

Fewer commercial “integral” PWR systems employing an internal steam generator have been produced. One contemplated approach is to adapt a reactor coolant pump of the type used in a boiling water reactor (BWR) for use in the integral PWR. Such arrangements have the advantages of good heat management (because the pump motor is located externally) and maintenance convenience (because the externally located pump is readily removed for repair or replacement).

However, the coupling of the external reactor coolant pump with the interior of the pressure vessel introduces vessel penetrations that, at least potentially, can be the location of a loss of coolant accident (LOCA).

Another disadvantage of existing reactor coolant pumps is that the pump operates in an inefficient fashion. Effective primary coolant circulation in a PWR calls for a pump providing high flow volume with a relatively low pressure head (i.e., pressure difference between pump inlet and outlet). In contrast, most reactor coolant pumps operate most efficiently at a substantially higher pressure head than that existing in the primary coolant flow circuit, and provide an undesirably low pumped flow volume.

Yet another disadvantage of existing reactor coolant pumps is that natural primary coolant circulation is disrupted as the primary coolant path is diverted to the external reactor coolant pumps. This can be problematic for emergency core cooling systems (EGGS) that rely upon natural circulation of the primary coolant to provide passive core cooling in the event of a failure of the reactor coolant pumps.

Another contemplated approach is to employ self-contained internal reactor coolant pumps in which the pump motor is located with the impeller inside the pressure vessel. However, in this arrangement the pump motors must be designed to operate inside the pressure vessel, which is a difficult high temperature and possibly caustic environment (e.g., the primary coolant may include dissolved boric acid). Electrical penetrations into the pressure vessel are introduced in order to operate the internal pumps. Pump maintenance is complicated by the internal placement of the pumps, and maintenance concerns are amplified by an anticipated increase in pump motor failure rates due to the difficult environment inside the pressure vessel. Still further, the internal pumps occupy valuable space inside the pressure vessel.

Disclosed herein are improvements that provide various benefits that will become apparent to the skilled artisan upon reading the following.

### BRIEF SUMMARY

In one aspect of the disclosure, an apparatus comprises a reactor coolant pump (RCP) configured to pump primary coolant water in a pressurized water reactor (PWR) comprising a pressure vessel containing a nuclear core comprising a fissile material immersed in primary coolant water. The RCP includes: a turbo pump comprising (i) an impeller arranged in the pressure vessel to circulate primary coolant through the pressure vessel and (ii) a turbine mechanically coupled with the impeller to drive the impeller; and an electrically driven hydraulic pump configured to pump primary coolant from the pressure vessel into the turbine to drive the turbo pump. In some embodiments, an inlet of the turbine is connected with the hydraulic pump to receive primary coolant pumped into the turbine to drive the turbo pump, but an outlet of the turbine is not connected with the hydraulic pump.

In another aspect of the disclosure, a method comprises: providing a pressurized water reactor (PWR) comprising a pressure vessel containing a nuclear core comprising a fissile material immersed in primary coolant water; pumping primary coolant using an electrically driven hydraulic pump to generate first primary coolant flow; and transforming the first primary coolant flow into second primary coolant flow circulating inside the pressure vessel, the second primary coolant flow having lower pressure and higher volume than the first primary coolant flow. In some embodiments the transforming comprises driving a hydraulically driven pump using the first primary coolant flow. For example, the hydraulically driven pump may be a turbo pump and the driving comprises driving a turbine of the turbo pump using the first primary coolant flow to rotate an impeller of the turbo pump to generate the second primary coolant flow.

In another aspect of the disclosure, an apparatus comprises: a pressurized water reactor (PWR) comprising a pressure vessel containing a nuclear core comprising a fissile material immersed in primary coolant water; and a reactor coolant pump configured to pump primary coolant water in the pressure vessel, the reactor coolant pump comprising a hydraulically driven turbo pump disposed in the pressure vessel. In some embodiments the turbo pump comprises an impeller performing pumping of primary coolant water in the pressure vessel, and a hydraulically driven turbine mechanically coupled with the impeller to drive the impeller.

### BRIEF DESCRIPTION OF THE DRAWINGS

The invention may take form in various components and arrangements of components, and in various process operations and arrangements of process operations. The drawings are only for purposes of illustrating preferred embodiments and are not to be construed as limiting the invention.

FIG. 1 diagrammatically shows a nuclear reactor including a reactor coolant pump (RCP) as disclosed herein.

FIG. 2 diagrammatically shows operation of the RCP of FIG. 1.

FIGS. 3 and 4 show two different perspective views of the turbo pump of the RCP of FIG. 1.

FIG. 5 shows an end view of the turbo pump of the RCP of FIG. 1.

FIG. 6 shows a partial sectional view of the RCP of FIG. 1 with the impeller duct omitted.

FIG. 7A diagrammatically shows a plan view of a lower vessel section of a nuclear reactor as disclosed herein.

FIG. 7B diagrammatically shows a cross sectional side view of a lower vessel portion of a nuclear reactor as disclosed herein.

FIGS. 8 and 9 show side and perspective views, respectively of RCPs shown in FIG. 7a.

FIG. 10 shows a side view of an alternative RCP in which a canned pump is replaced by an external hydraulic working fluid source.

FIG. 11 shows a perspective view of an alternative turbo pumps assembly suitable for installation and operation inside the central riser of the nuclear reactor of FIG. 1.

FIG. 12 shows a sectional perspective view of the assembly of FIG. 11 installed in the central riser, where only an upper portion of the nuclear reactor is shown.

FIGS. 13-16 show views of an alternative turbo pump assembly suitable for installation and operation in a lower portion of a upper vessel section of a nuclear reactor

FIGS. 17-20 show views of an another alternative turbo pump assembly suitable for installation and operation in a upper portion of a upper vessel section of a nuclear reactor.

### DETAILED DESCRIPTION OF THE PREFERRED EMBODIMENTS

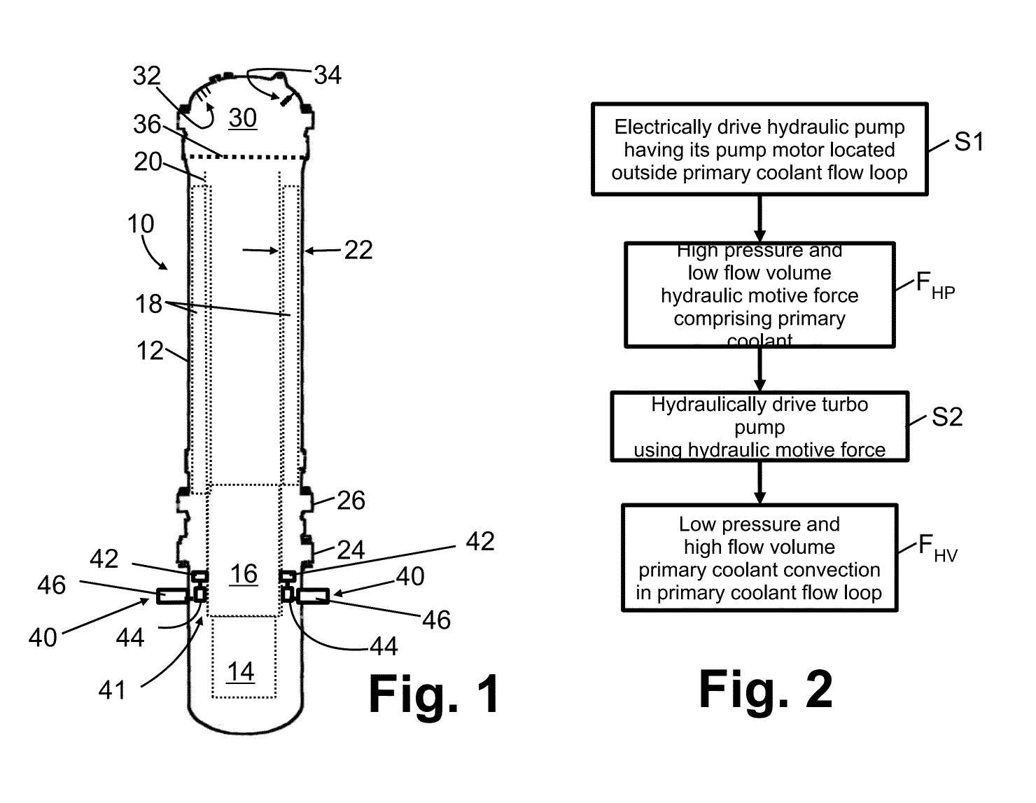

With reference to FIG. 1, an illustrative nuclear reactor of the pressurized water reactor (PWR) type 10 includes a pressure vessel 12, which in the illustrative embodiment is a cylindrical vertically mounted vessel. As used herein, the phrase “cylindrical pressure vessel” or similar phraseology indicates that the pressure vessel has a generally cylindrical shape, but may in some embodiments deviate from a mathematically perfect cylinder. For example, the illustrative cylindrical pressure vessel 12 has a circular cross-section of varying diameter along the length of the cylinder, and has rounded ends, and includes various vessel penetrations, vessel section flange connections, and so forth. Similarly, although the pressure vessel 12 is upright, it is contemplated for this upright position to deviate from exact vertical orientation of the cylinder axis. For example, if the PWR is disposed in a maritime vessel then it may be upright but with some tilt, which may vary with time, due to movement of the maritime vessel on or beneath the water.

Selected components of the PWR that are internal to the pressure vessel 12 are shown diagrammatically in phantom (that is, by dotted lines). A nuclear reactor core 14 is disposed in a lower portion of the pressure vessel 12. The reactor core 14 includes a mass of fissile material, such as a material containing uranium oxide (UO₂) that is enriched in the fissile ²³⁵U isotope, in a suitable matrix material. In a typical configuration, the fissile material is arranged as “fuel rods” arranged in a core basket. The pressure vessel 12 contains primary coolant water (typically light water, that is, H₂O, although heavy water, that is, D₂O, is also contemplated) in a subcooled state.

A control rods system 16 is mounted above the reactor core 14 and includes control rod drive mechanism (CRDM) units and control rod guide structures configured to precisely and controllably insert or withdraw control rods into or out of the reactor core 14. The illustrative control rods system 16 employs internal CRDM units that are disposed inside the pressure vessel 12. Some illustrative examples of suitable internal CRDM designs include: Stambaugh et al., “Control Rod Drive Mechanism for Nuclear Reactor”, U.S. Pub. No. 2010/0316177 A1 published Dec. 16, 2010 which is incorporated herein by reference in its entirety; and Stambaugh et al., “Control Rod Drive Mechanism for Nuclear Reactor”, Intl Pub. WO 2010/144563 A1 published Dec. 16, 2010 which is incorporated herein by reference in its entirety. In general, the control rods contain neutron absorbing material, and reactivity is increased by withdrawing the control rods or decreased by inserting the control rods. So-called “gray” control rods are continuously adjustable to provide incremental adjustments of the reactivity. So-called “shutdown” control rods are designed to be inserted as quickly as feasible into the reactor core to shut down the nuclear reaction in the event of an emergency. Various hybrid control rod designs are also known. For example, a gray rod may include a mechanism for releasing the control rod in an emergency so that it falls into the reactor core 14 thus implementing a shutdown rod functionality. Internal CRDM designs have advantages in terms of compactness and reduction in mechanical penetrations of the pressure vessel 12; however, it is also contemplated to employ a control rods system including external CRDM located outside of (e.g., above) the pressure vessel and operatively connected with the control rods by connecting rods that pass through suitable mechanical penetrations into the pressure vessel.

The illustrative PWR 10 is an integral PWR, and includes an internal steam generator 18 disposed inside the pressure vessel 12. In the illustrative configuration, a central riser 20 is a cylindrical element disposed coaxially inside the cylindrical pressure vessel 12. (Again, the term “cylindrical” is intended to encompass generally cylindrical risers that deviate from a perfect cylinder by variations in diameter along the cylinder axis, inclusion of selected openings, or so forth). The riser 20 surrounds the control rods system 16 and extends upward, such that primary coolant water heated by the operating nuclear reactor core 14 rises upward through the central riser 20 toward the top of the pressure vessel, where it discharges, reverses flow direction and flows downward through an outer annulus defined between the central riser 20 and the cylindrical wall of the pressure vessel 12. The illustrative steam generator 18 is an annular steam generator disposed in a downcomer annulus 22 defined between the central riser 20 and the wall of the pressure vessel 12. The steam generator 18 provides independent but proximate flow paths for downwardly flowing primary coolant and upwardly flowing secondary coolant. The secondary coolant enters at a feedwater inlet 24, flows upward through the steam generator 18 where it is heated by the proximate downwardly flowing primary coolant to be converted to steam, and the steam discharges at a steam outlet 26.

FIG. 1 does not illustrate the detailed structure of the steam generator 18 or the secondary coolant flow path. For example, feedwater inlet tubes and/or a feedwater plenum convey feedwater from the inlet 24 to the bottom of the steam generator 18, and steam outlet tubes and/or a steam plenum convey steam from the top of the steam generator 18 to the steam outlet 26. Typically, the steam generator comprises steam generator tubes and a surrounding volume (or “shell”) containing the tubes, thus providing two proximate flow paths that are in fluid isolation from each other. In some embodiments, the primary coolant flows downward through the steam generator tubes (that is, “tube-side”) while the secondary coolant flows upward through the surrounding volume (that is, “shell-side”). In other embodiments, the primary coolant flows downward through the surrounding volume (shell-side) while the secondary coolant flows upward through the steam generator tubes (tube-side). In either configuration, the steam generator tubes can have various geometries, such as vertical straight tubes (sometimes referred to as a straight-tube once-through steam generator or “OTSG”), helical tubes encircling the central riser 20 (some embodiments of which are described, by way of illustrative example, in Thome et al., “Integral Helical Coil Pressurized Water Nuclear Reactor”, U.S. Pub. No. 2010/0316181 A1 published Dec. 16, 2010 which is incorporated herein by reference in its entirety), or so forth.

The pressure vessel 12 defines a sealed volume that, when the PWR is operational, contains primary coolant water in a subcooled state. Toward this end, the PWR includes an internal pressurizer volume 30 disposed at the top of the pressure vessel 12 containing a steam bubble whose pressure controls the pressure of the primary coolant water in the pressure vessel 12. The pressure is controlled by suitable devices such as a heater 32 (e.g., one or more resistive heaters) that heats the steam to increase pressure, and/or a sparger 34 that injects cool water or steam into the steam bubble to reduce pressure. A baffle plate 36 separates the internal pressurizer volume 30 from the remainder of the sealed volume of the pressure vessel 10. By way of illustrative example, in some embodiments the primary coolant pressure in the sealed volume of the pressure vessel 12 is at a pressure of about 2000 psia and at a temperature of about 300° C. (cold leg just prior to flowing into the reactor core 14) to 320° C. (hot leg just after discharge from the reactor core 14). These are merely illustrative subcooled conditions, and a diverse range of other operating pressures and temperatures are also contemplated. Moreover, the illustrative internal pressurizer can be replaced by an external pressurizer connected with the pressure vessel by suitable piping or other fluid connections.

A reactor coolant pump (RCP) 40 is configured to drive circulation of primary coolant water in the pressure vessel 12. The reactor coolant pump comprises a hydraulically driven turbo pump 41 disposed in the pressure vessel. In a suitable embodiment, the turbo pump 41 includes an impeller 42 performing pumping of primary coolant water in the pressure vessel 12, and a hydraulically driven turbine 44 mechanically coupled with the impeller 42 to drive the impeller 42. A hydraulic pump 46 pumps primary coolant water to generate hydraulic working fluid that drives the turbine 42.

With reference to FIG. 2, operation of the reactor coolant pump 40 is described. In an operation S1, the hydraulic pump 46 is electrically driven. The pump motor of the hydraulic pump 46 is located outside the primary coolant flow loop, which has an advantage in that it is not exposed to the high temperature (e.g., 300-320° C. in some embodiments, although higher or lower coolant temperature is also contemplated) of the primary coolant. The hydraulic pump 46 operates to pump the primary coolant. However, it directly pumps only a relatively small portion of the total volumetric primary coolant flow passing downward through the downcomer annulus 22. The pumping S1 performed by the hydraulic pump 46 produces a high pressure flow F_{HP} which however is a relatively low volume flow. In an operation S2, the turbo pump including the turbine 44 and impeller 42 acts as a flow transformer to convert the high pressure flow F_{HP} to a higher volume (but lower pressure) flow F_{HV}. That is, in the operation S2 the high pressure flow F_{HP} drives the turbine 44 which in turn drives the mechanically coupled impeller 42 to generate the high volume flow F_{HV} which flows in the primary coolant flow loop (e.g., down the downcomer annulus 22).

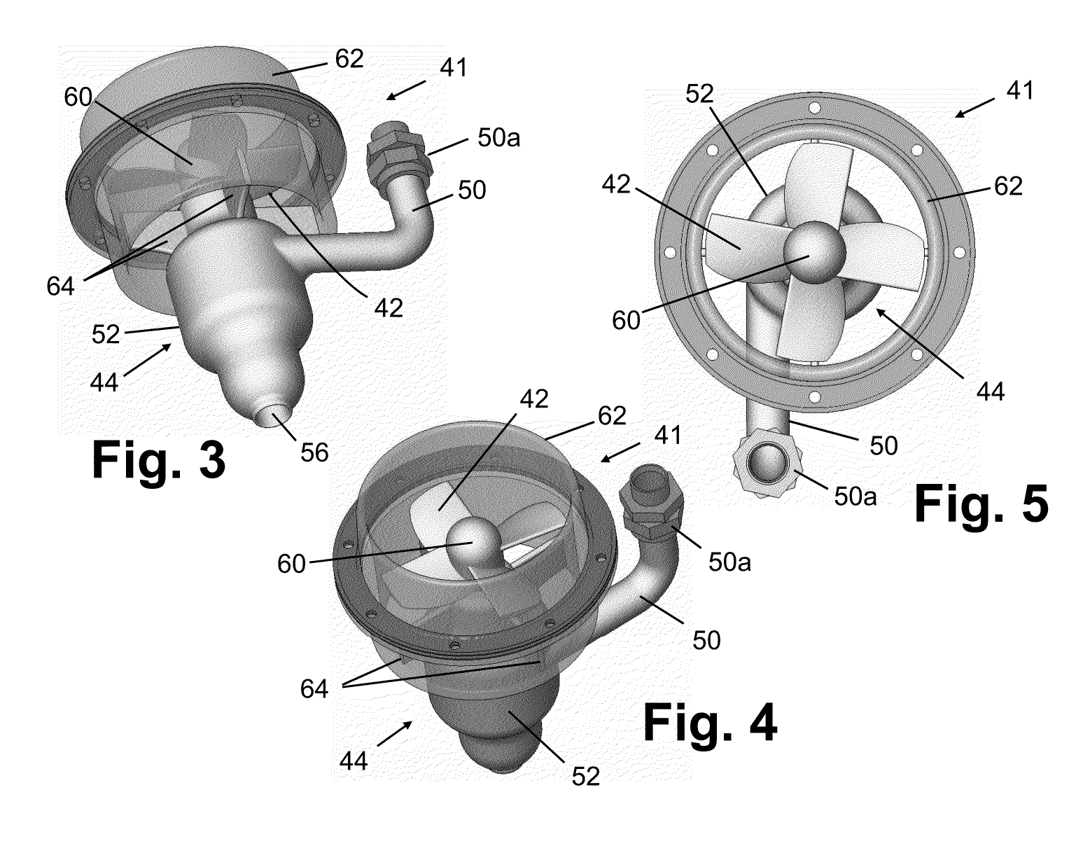

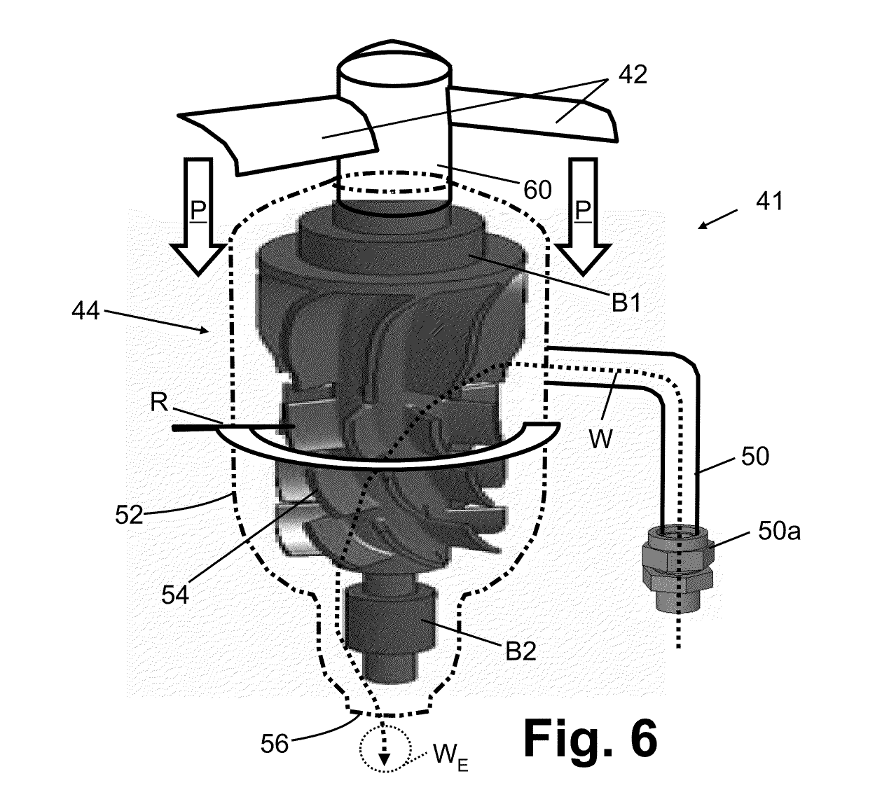

With reference to FIGS. 3-6, an illustrative embodiment of the turbo pump is shown. Hydraulic working fluid W (diagrammatically indicated in FIG. 6) flows through an inlet 50 to a turbine chamber defined by a turbine housing 52. The flow of working fluid W into the turbine chamber causes a turbine rotor 54 to rotate in a rotational direction R indicated in FIG. 6. In the illustrative example of FIG. 6 (where the turbine housing 52 is shown in phantom to reveal internal components), the hydraulic working fluid W is injected into the turbine chamber on the side in a tangential direction to the turbine rotor 54. The hydraulic working fluid W imparts momentum to turbine blades of the turbine rotor 54. The turbine blades are shaped to convert the momentum of the working fluid W into the rotation R, and also to redirect the flow of the working fluid W generally toward an outlet 56 of the turbine 44. (Note that the outlet 56 is visible in FIGS. 3 and 6 but not in FIGS. 4 and 5.) The turbine blades may, for example, be of the axial or tangential or centrifugal type, or a combination thereof, with gaps or so forth in order to produce the desired combination of imparting the rotational force on the rotor 54 and redirecting flow of the working fluid W toward the outlet 56. The working fluid W discharges out of the turbine 44 via the outlet 56, which is on the opposite end of the turbine 44 from the flow impeller 42.

The turbine rotor 54 is mounted on a shaft 60, and the impeller 42 mounted on the same shaft 60 as the turbine rotor 54—therefore, the impeller 42 rotates in same the rotational direction R as the turbine rotor 54. More generally, the hydraulically driven turbine 44 is mechanically coupled with the impeller 42 to drive the impeller 42. In the illustrative approach this mechanical coupling is via the common shaft 60; however, it is also contemplated to include a more complex coupling with gearing or so forth. The illustrative shaft 60 is supported in the turbine housing 52 by suitable bearings B1, B2.

The blades of the impeller 42 are immersed in the primary coolant, and are shaped such that they drive a primary coolant flow P as shown in FIG. 6. In the illustrative example, the impeller 42 directs the primary coolant flow P across the turbine housing 52 in the same general direction as the turbine exhaust W_{E} discharged from the outlet 56 by the turbine 44 (see FIG. 6). The illustrative impeller 42 is of the axial flow type, although other impeller types with radial (centrifugal) flow characteristics, mixed radial/axial flow characteristics, or so forth may be employed. The impeller 42 is enclosed within a tubular housing or impeller duct 62 (omitted in FIG. 6, and shown in partial phantom in FIGS. 3 and 4, to reveal internal components). In the embodiment of FIGS. 2-6 the impeller duct 62 is secured to the turbine housing 52 by four connecting plate members 64 radially spaced apart by 90° intervals; alternatively, in other embodiments the impeller duct may be secured elsewhere, or may be omitted entirely.

The impeller 42 directs the primary coolant flow P across the turbine housing 52 in the same general direction as the turbine exhaust W_{E} discharged from the outlet 56 by the turbine 44. Thus, the turbine exhaust flow W_{E} additively combines with the primary coolant flow P to form the total discharge from the turbo pump. This is advantageous assuming that the electrically driven hydraulic pump 46 supplies the hydraulic working fluid W as primary coolant and/or as make-up water for making up lost primary coolant. In this arrangement, there is a single fluid connection, namely the inlet 50, connecting (via a connecting apparatus 50a in some embodiments), the electrically driven hydraulic pump 46 and the turbo pump 41 (or, more specifically, a single fluid connection 50 connecting the hydraulic pump 46 and the turbine 44). In particular, the outlet 56 is not connected with the hydraulic pump 46.

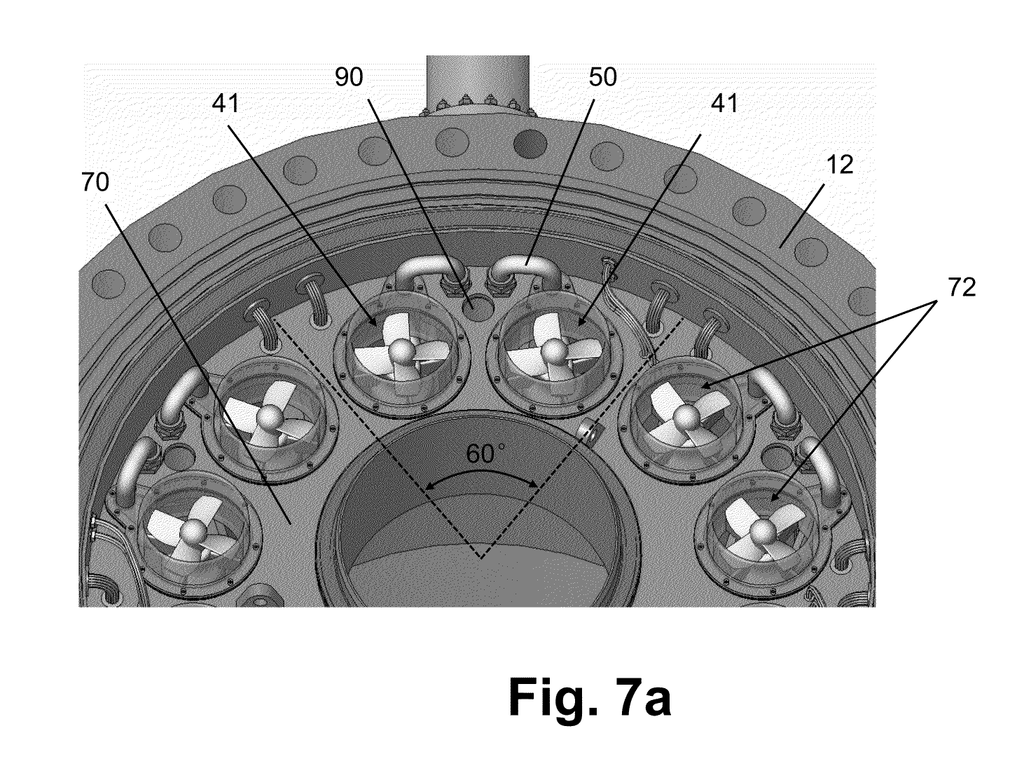

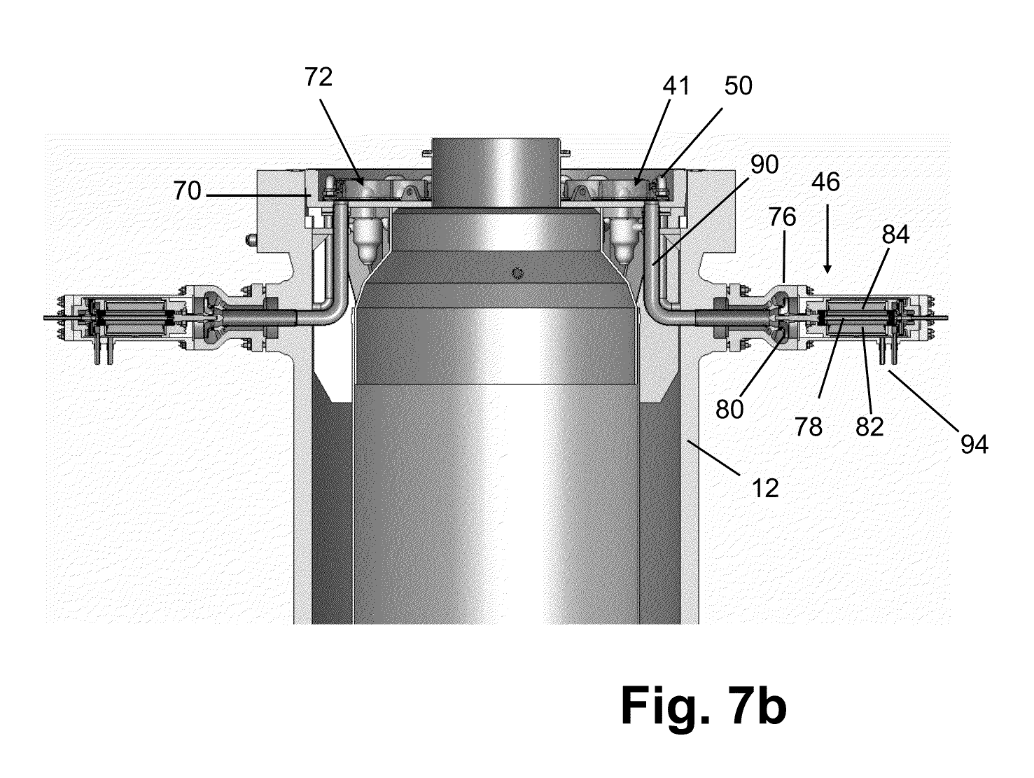

With reference to FIG. 7-9, a suitable arrangement of the pumps shown in FIGS. 3-6 in the PWR of FIG. 1 is shown in further detail. An annular plate 70 is disposed in the downcomer annulus 22. Each turbo pump is mounted at an opening 72 of the annular plate 70. In the illustrative arrangement, each electrically driven hydraulic pump 46 drives the turbines 44 of two turbo pumps 41. The annular plate 70 includes twelve openings 72 for supporting twelve turbo pumps; however, other numbers of turbo pumps (including as few as a single turbo pump) may be employed, and the turbo pump-to-hydraulic pump ratio may be 1:1, 2:1 (as shown in FIG. 7), 3:1, or so forth, depending upon the load capacity of the hydraulic pumps. In addition to providing a mounting structure for the turbo pumps, the annular plate 70 separates the high pressure side (above the plate 70) and low pressure side (below the plate 70) of the turbo pumps 41. Toward this end, in some embodiments the impeller ducts 62 are sized to mate with the openings 72 so that primary coolant flow is limited to going through the impeller ducts 62 or through the inlet 90 to form the hydraulic working fluid W.

The illustrative electrically driven hydraulic pumps 46 are external canned motor pumps that feed the inlets 50 of two turbines 44 with relatively short hydraulic lines that are internal to the pressure vessel 12. The canned motor pumps are suitably mounted on respective flanged openings in the pressure vessel 12. In these embodiments a canned motor pump housing 76 of the pump 46 is part of the primary pressure boundary also including the pressure vessel 12. In these canned pump designs, there is no seal between the shaft 78 of the working fluid pump 80 and the motor (comprising a stator 82 and a rotor 84). The internals of the electrically driven hydraulic pump 46 are wet at the primary pressure. This type of pump is known for use as boiler circulation pumps. The canned motor pump external housing 76 is effectively an extension of the reactor vessel primary boundary defined by the pressure vessel 12.

In operation, a portion of the primary coolant flow P flowing downward in the downcomer annulus 22 is captured by an inlet 90 and flows into the electrically driven hydraulic pump 46. This captured primary coolant forms the hydraulic working fluid W, and is pressurized by operation of the hydraulic pump 46 (and more particularly by the operation of the working fluid pump 80 driven by the motor 82, 84). The pump 80 discharges the working fluid W into the inlet 50 of the turbine 44 where it drives the turbine rotor 54 (see FIG. 6) and the impeller 42 via the common driveshaft 60. In some embodiments, about ⅛th (i.e., about 10-15%) of the primary coolant flow P is captured by the inlet 90 and forms the working fluid W. An off-the-shelf boiler circulation pump typically has a head of around 200 psi, whereas some contemplated small modular reactor (SMR) designs of the integral PWR type are expected to have a head of about 21 psi. Thus, an off-the-shelf canned motor pump of the type commonly used for boiler circulation is expected to be well-suited for use as the electrically driven hydraulic pump 46.

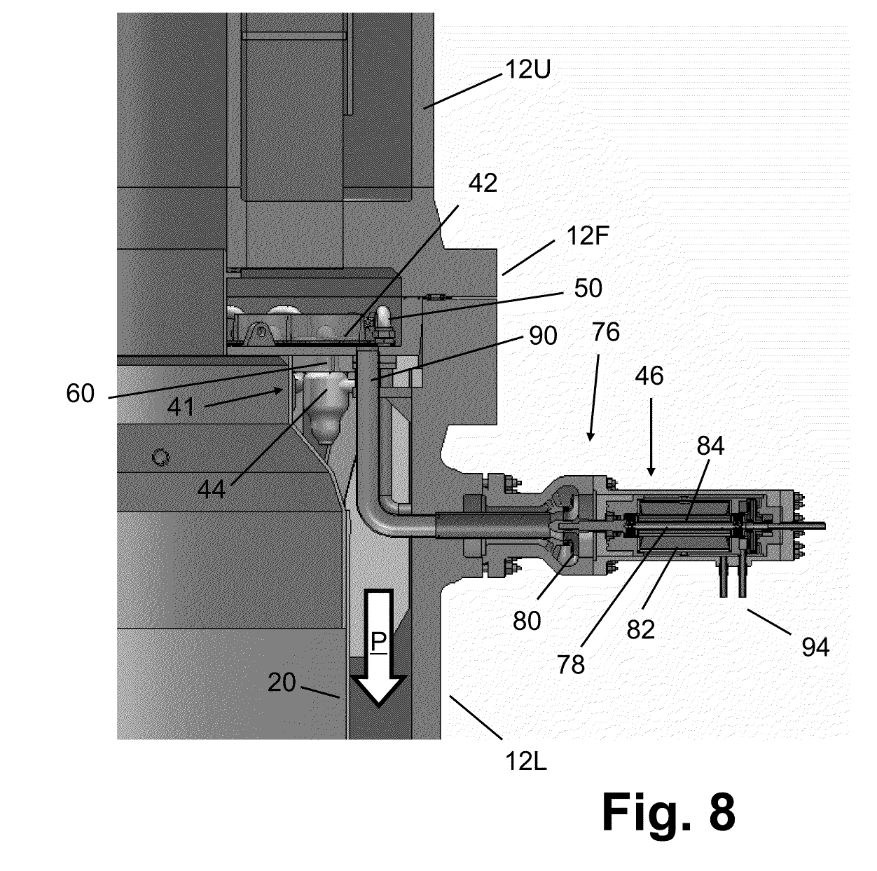

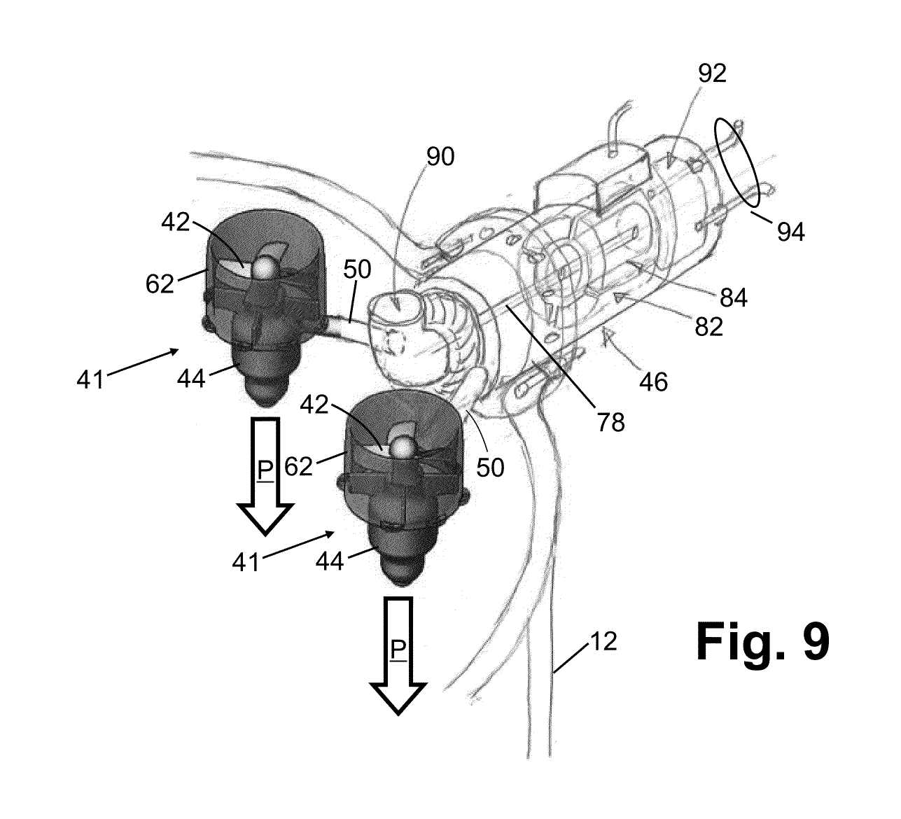

With particular reference to FIG. 8, in some embodiments the pressure vessel 12 is constructed in two sections, i.e. an upper section 12U and a lower section 12L, that are joined at a vessel flange 12F. In such embodiments the turbo pump 41 is readily accessible when the upper pressure vessel section 12U is lifted off by a crane or other lifting device during maintenance operations. Alternatively, access may be provided by manways, or the RCPs 40 may be located closer to the top of the pressure vessel and be accessible when a vessel head is lifted off for maintenance.

In the illustrative embodiment in which the electrically driven hydraulic pumps 46 are canned pumps, the pumps 46 are expected to receive a substantial amount of heat from the reactor. Accordingly, in some embodiments provision is made for cooling the electrically driven hydraulic pumps 46. In one embodiment, a heat exchanger (not shown) is employed for this purpose. The “hot” side of the heat exchanger flows fluid from inside the pump 46, while the “cold” side of the heat exchanger is cooled by active flow of coolant delivered via coolant lines 94.

The RCP embodiments described with reference to FIGS. 1-9 provide numerous advantages. The design enables the electrically driven hydraulic pump 46 to operate at or near its point of optimal efficiency, while still providing high volume (but lower pressure) flow via the transformative action of the turbo pumps 41. In effect, the turbo pumps transform the excess pressure head of the pump 46 into volumetric flow. The external pump in the illustrative embodiment comprises a canned pump mounted on a flanged opening, which reduces vessel penetrations. Indeed, if the canned pump is treated as part of the pressure vessel boundary, then there are only the electrical penetrations for powering the canned pump 46. The turbo pumps located inside the pressure vessel 12 can have as few as a single moving part, if the impeller 42 and the turbine rotor 54 of the turbine 44 define a unitary rotating element. The RCPs are located in the reactor downcomer annulus 22, and so the RCPs can remain in place during refueling, and do not need to be removed to access the reactor core 14. On the other hand, the electrically driven hydraulic pumps 46 are mounted on an exterior flange and can be removed for repair or replacement without disassembling the reactor.

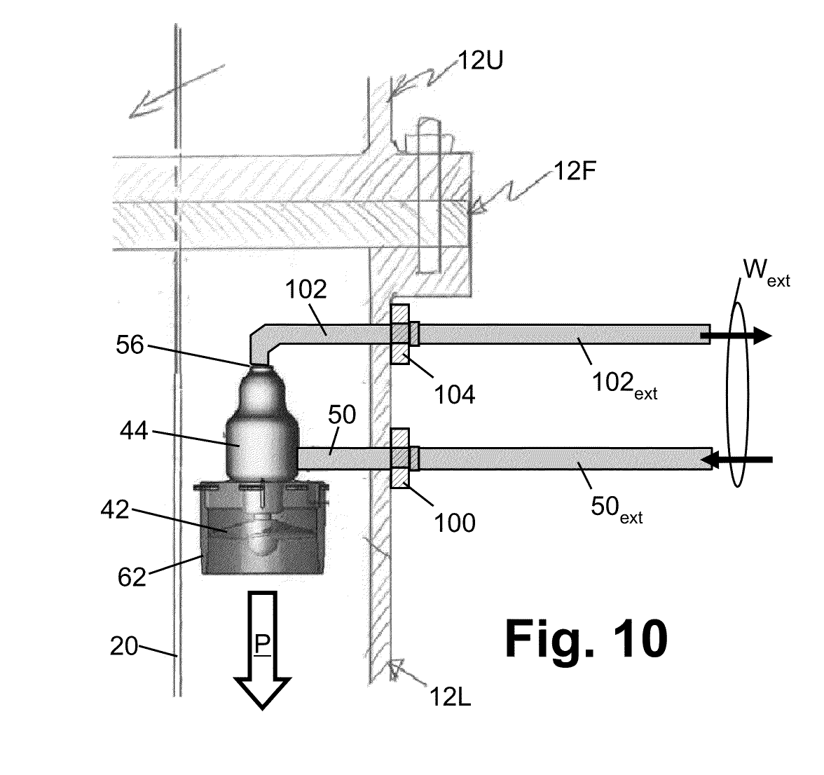

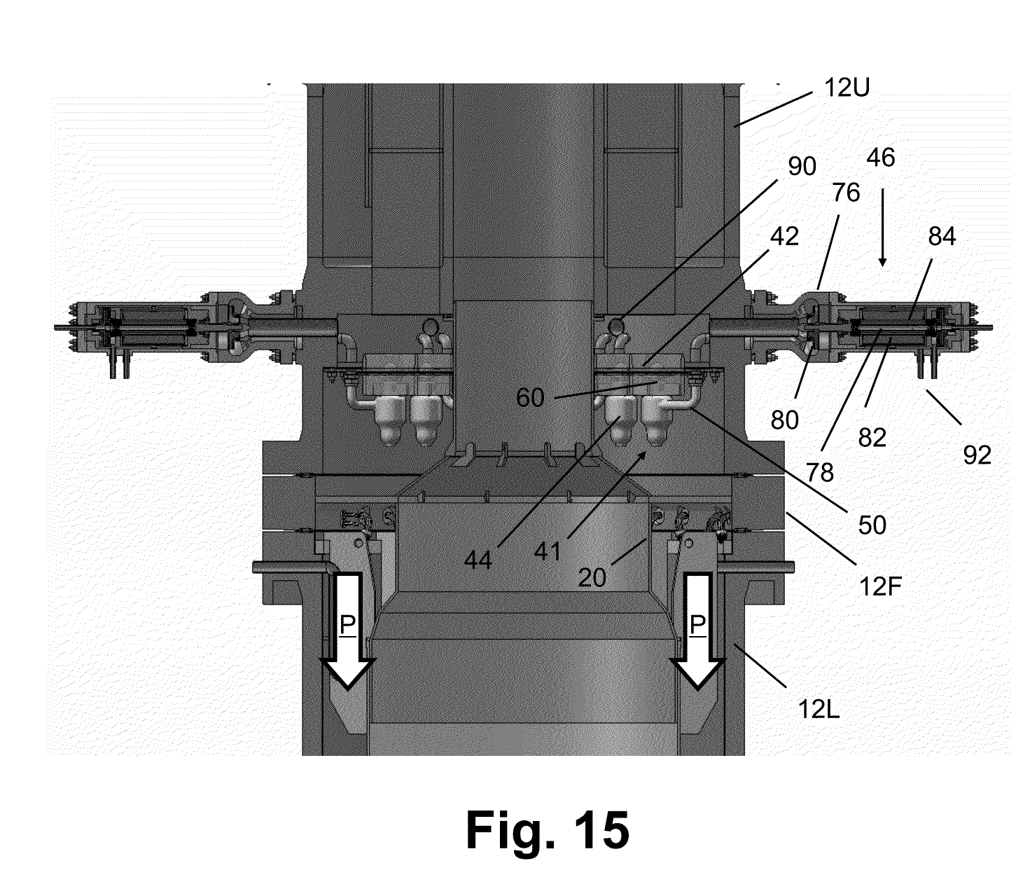

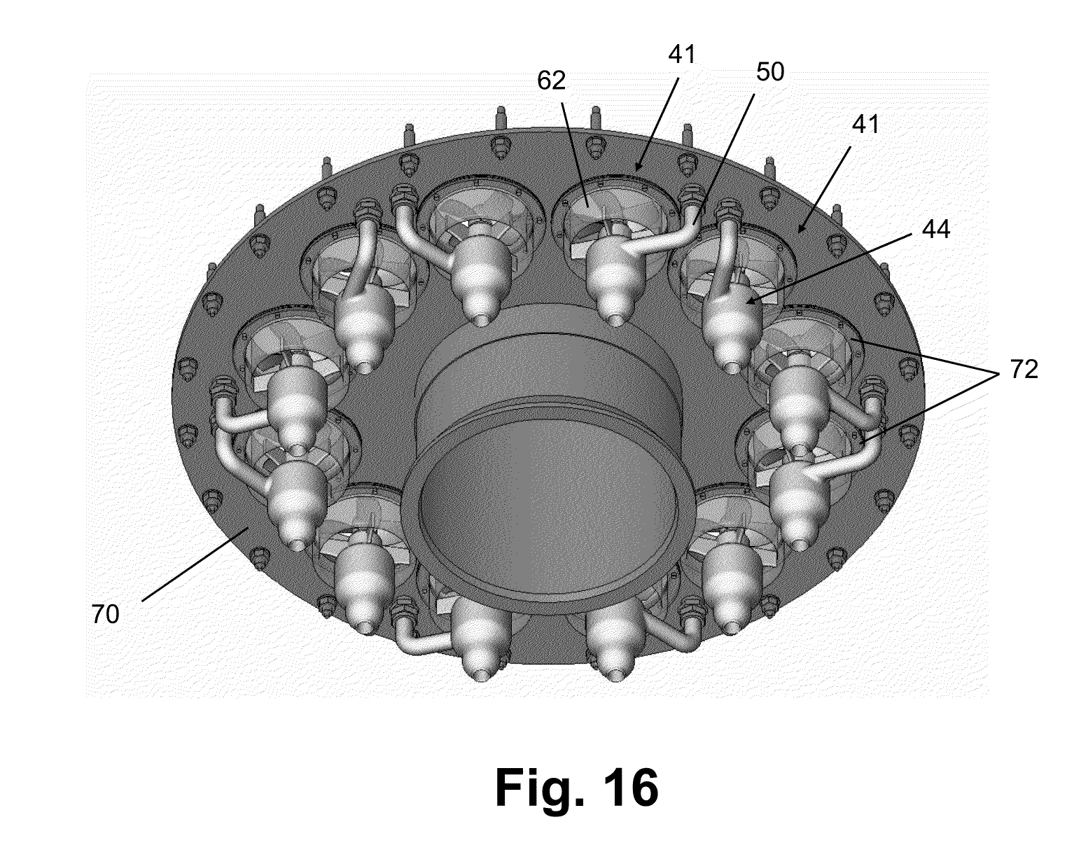

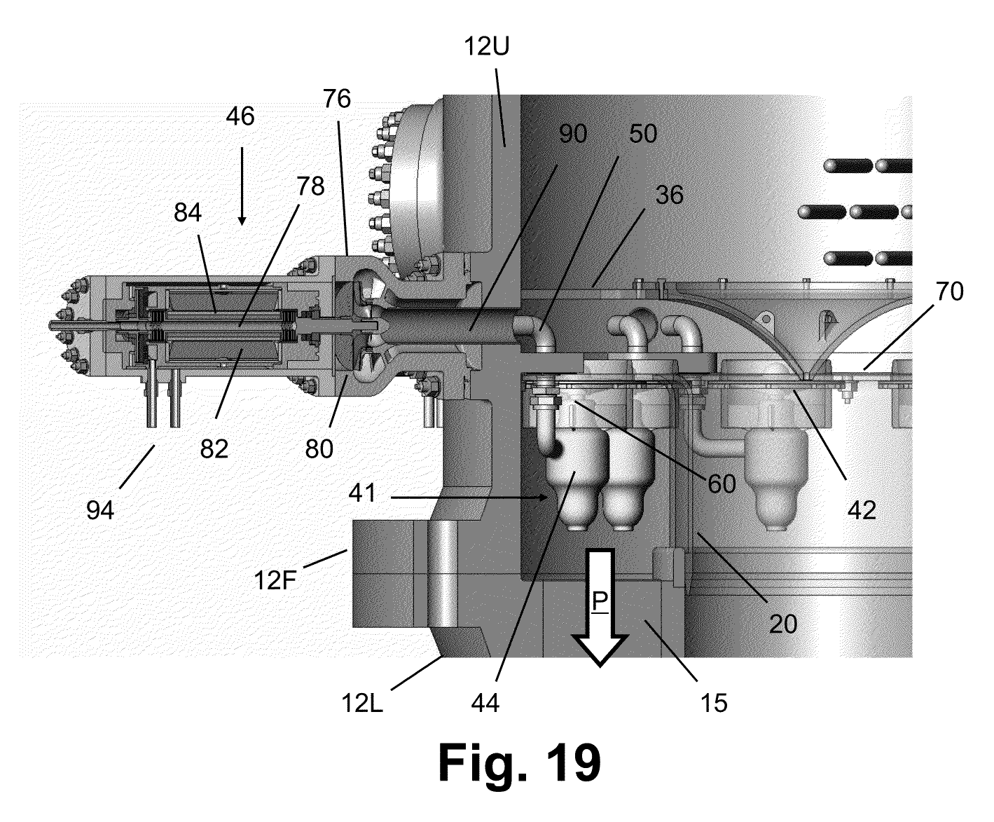

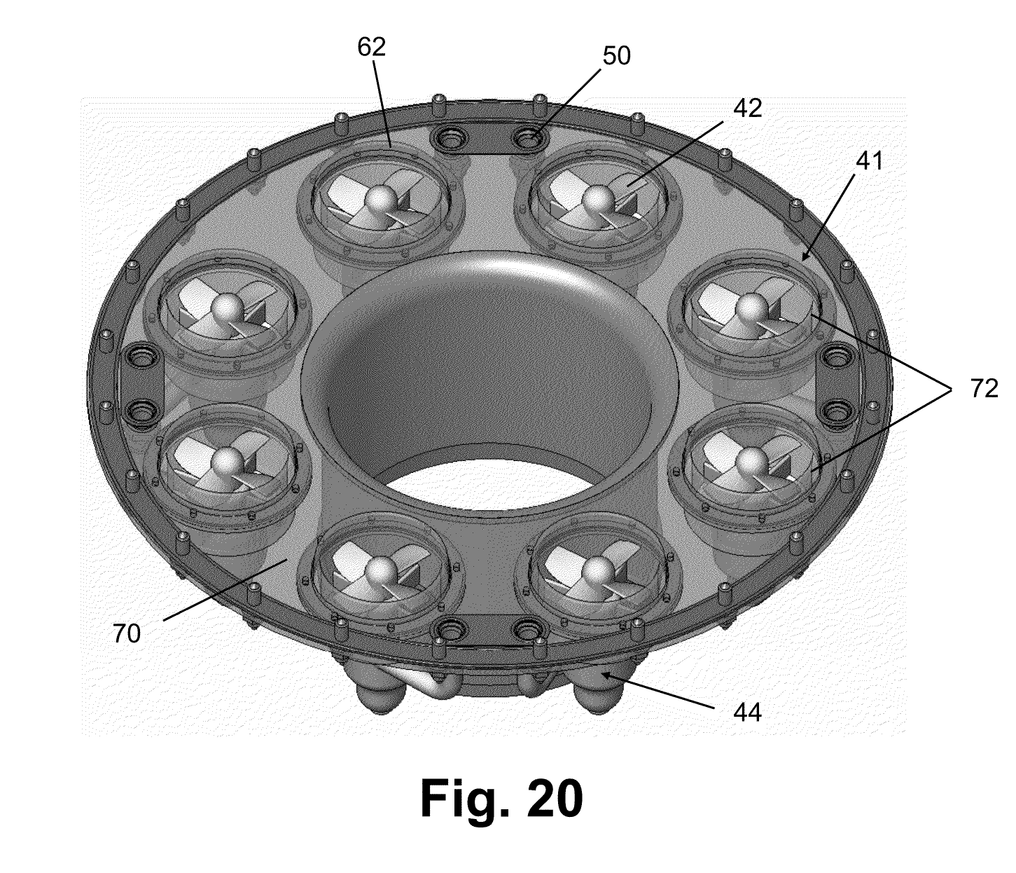

The embodiments of FIGS. 1-9 are merely illustrative, and numerous variations are contemplated. For example, the illustrated canned pump embodiment of the electrically driven hydraulic pumps 46 can be replaced by dry pump, an external pump that is not mounted to the pressure vessel 12, or so forth. FIGS. 10-20 illustrate some variant embodiments.

With reference to FIG. 10, in one variant embodiment the canned electrically driven hydraulic pump 46 flange-mounted onto the pressure vessel 12 is replaced by an external source of hydraulic working fluid Wₑₓₜ. Toward this end the inlet 50 is connected with a vessel penetration 100. At the exterior of the pressure vessel 12, an inlet pipe 50ₑₓₜ supplying the working fluid Wₑₓₜ feeds into the vessel penetration 100. The outlet 56 of the turbine 44 in this embodiment is coupled by a short pipe 102 with a second vessel penetration 104. At the exterior of the pressure vessel 12, an outlet pipe 102ₑₓₜ carries away the hydraulic working fluid Wₑₓₜ exiting from the turbine 44. Because in this embodiment the discharge from the outlet 56 of the turbine 44 does not add to the pumped primary coolant flow P, the embodiment of FIG. 10 optionally “flips” the turbo pump so that the impeller 42 discharges the primary coolant flow P away from the turbine 44. This also entails redesign of the impeller blades to optimize them for the orientation shown in FIG. 10.

The design of FIG. 10 has the disadvantage of introducing vessel penetrations 100, 104. However, these penetrations can be of small diameter so as to reduce the likelihood of and/or likely severity of a LOCA at these penetrations. An advantage of the design of FIG. 10 is that the external pipes 50ₑₓₜ, 102ₑₓₜ provide flexibility as to the source of the working fluid Wₑₓₜ. In some embodiments the working fluid may be primary coolant taken from a reactor coolant inventory and purification system (RCIPS). In other embodiments the working fluid Wₑₓₜ may be something other than reactor coolant, e.g. a separate water supply.

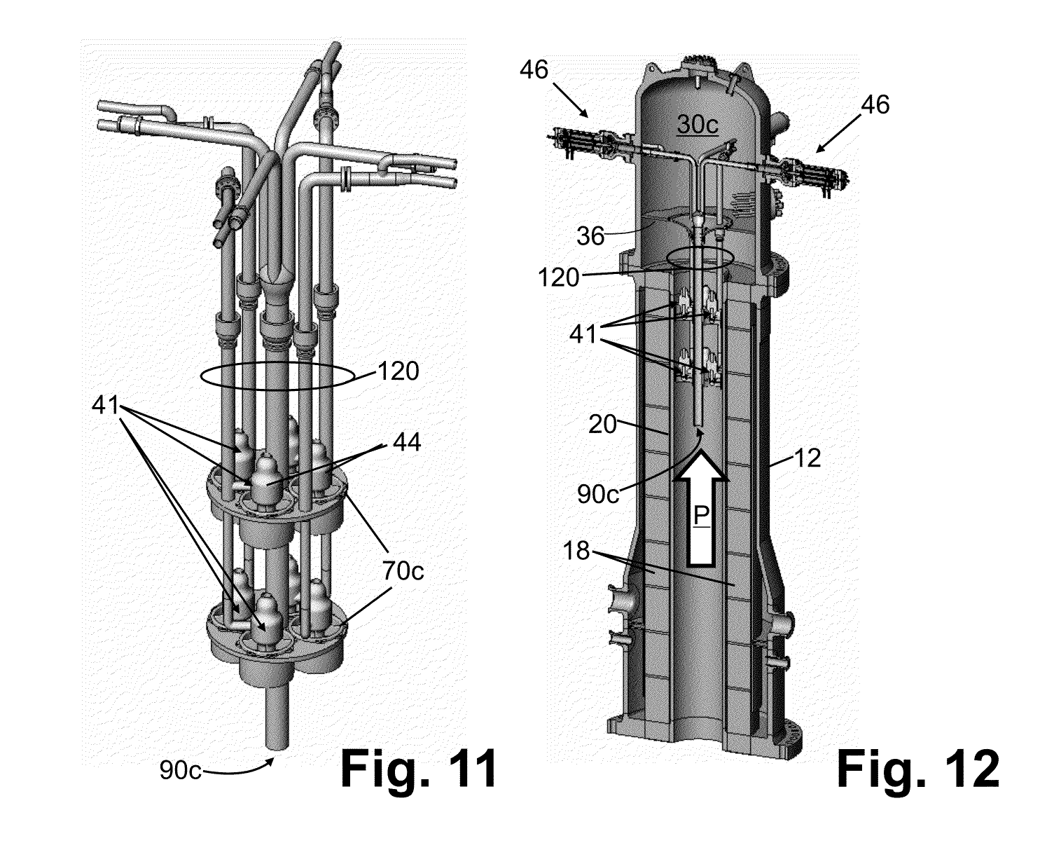

With reference to FIGS. 11 and 12, in another variant embodiment the turbo pumps are located inside the central riser 20, rather than being located in the annular downcomer annulus 22 as in the embodiments of FIGS. 1-10. The embodiment of FIGS. 11 and 12 is like the embodiment of FIGS. 1-9 in that a fraction of the primary coolant flow is captured and used as the hydraulic working fluid for driving the turbines 44. However, in the central riser, the pumped primary coolant flow P is upward. Accordingly, the inlet 90 (see, e.g. FIG. 9) is replaced by an inlet 90c embodied as an open lower end of a pipe centrally located inside the central riser 20. The turbo pumps 41 are also inverted as compared with the embodiment of FIGS. 1-9, so that the turbines 44 discharge upward in order to additively combine with the primary coolant flow P. Because the turbo pumps 41 located inside the central riser 20 are not proximate to the outer wall of the pressure vessel 12, a piping manifold 120 is provided to convey the captured primary coolant out to the electrically driven hydraulic pumps and to convey the resulting hydraulic working fluid back to the turbo pumps 41 inside the central riser 20.

In the alternative embodiment of FIGS. 11 and 12, the turbo-pumps 41 are mounted on annular plates 70c in the hot leg of the primary coolant flow circuit, that is, inside the central riser 20 in the illustrative embodiment. A configuration of eight turbo-pumps in two groups of four is shown in FIGS. 11 and 12. The open loop feed lines are routed through a modified pressurizer 30c at the top of the pressure vessel 12. The inlet 90c for the electrically driven hydraulic pump or pumps is embodied as the larger pipe in the center of the piping manifold 120. In the illustrative manifold 120, the inlet 90c branches to four external hydraulic pumps (not shown, but suitably mounted next to the pressurizer 30c). Four return lines each feed the turbines 44 of two turbo-pumps 41 so as to drive all eight turbo pumps 41.

In this configuration, the turbo-pumps 41 are mounted inverted (as compared with the embodiment of FIGS. 1-9) so that the impeller drives the primary coolant flow P upward and the turbines 44 discharge upward. The electrically driven hydraulic pumps are not shown in FIGS. 11 and 12, but are suitably mounted on the pressurizer 30c in either a vertical or horizontal orientation. These pumps could remain mounted on the pressurizer when the latter is lifted off and moved aside during refueling. (The electrical feeds and any heat exchanger cooling lines would likely be disconnected during this operation). Likewise, the connections to the turbo-pumps 41 optionally would remain intact during refueling.

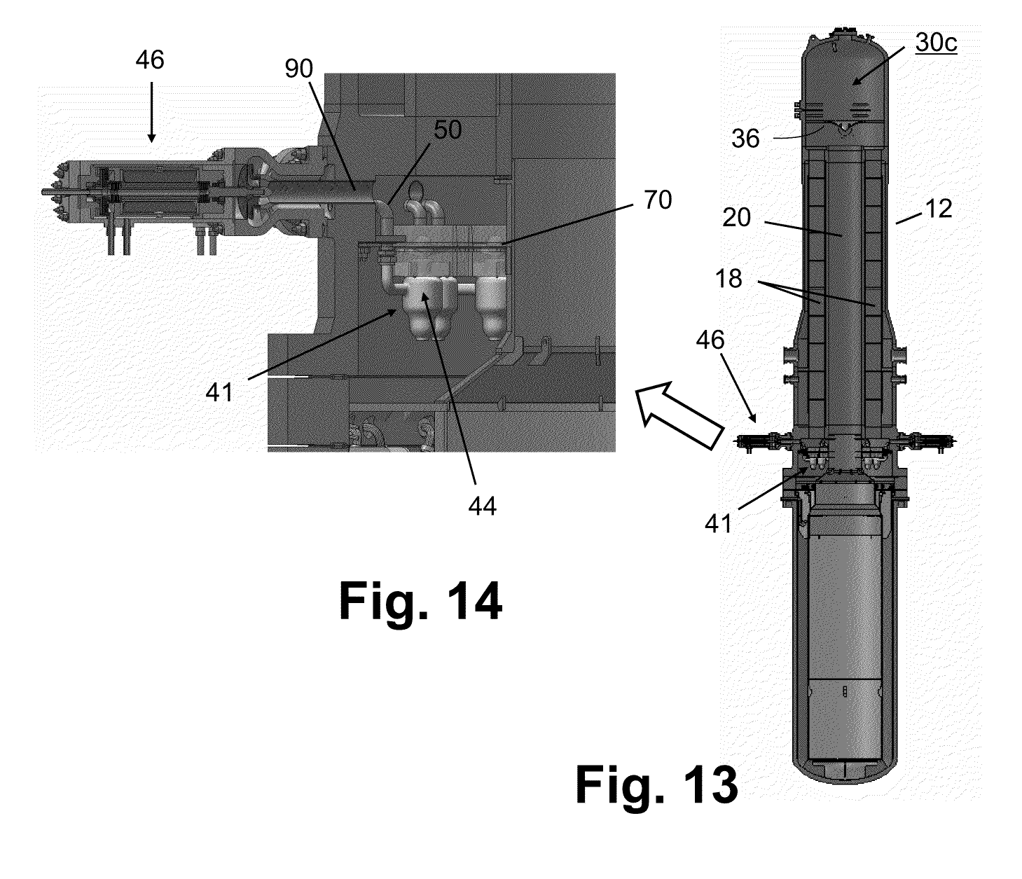

In the alternative embodiments of FIGS. 13-16, turbo pumps 41 are mounted on an annular plate located in a lower portion of the upper vessel section 12U. Operation is similar to that already discussed with the exception that hydraulic pumps may alternatively be positioned at an elevation above the annular plate 70. In this arrangement, the working fluid portion of the primary coolant flowing downward in the downcomer is captured by an inlet 90 on the low pressure side of the annular plate 70 and flows into the hydraulic pump 46 without first passing through the annular plate 70.

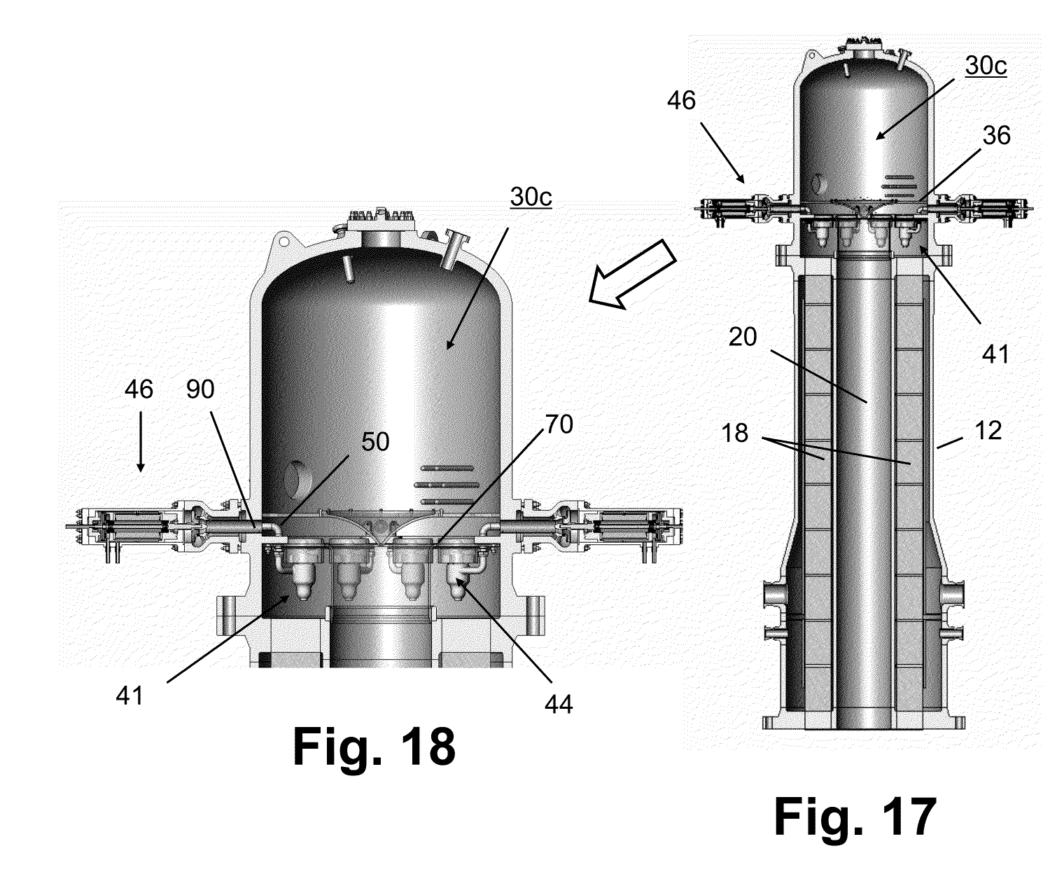

In the alternative embodiment of FIGS. 17-20, turbo pumps 41 are mounted on an annular plate located in an upper portion of the upper vessel section 12U. Operation is similar to that of the embodiments of FIGS. 13-16. However, in this embodiment, turbo pumps 41 are mounted between the primary coolant fluidic entrance 15 to the internal steam generator 18 and the baffle plate 36.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

We claim:

1. An apparatus comprising:
a reactor coolant pump (RCP) configured to pump primary coolant water in a pressurized water reactor (PWR) comprising a pressure vessel containing a nuclear core comprising a fissile material immersed in primary coolant water, the RCP including:
a turbo pump comprising (i) an impeller arranged in the pressure vessel to circulate primary coolant through the pressure vessel and (ii) a turbine mechanically coupled with the impeller to drive the impeller, and
an electrically driven hydraulic pump configured to pump primary coolant from the pressure vessel into the turbine to drive the turbo pump.

2. The apparatus of claim 1, wherein the primary coolant pumped into the turbine by the hydraulic pump is discharged into the pressure vessel.

3. The apparatus of claim 1, wherein an inlet of the turbine is connected with the hydraulic pump to receive primary coolant pumped into the turbine to drive the turbo pump, but an outlet of the turbine is not connected with the hydraulic pump.

4. The apparatus of claim 1, wherein the hydraulic pump includes a casing defining a portion of the pressure boundary of the pressure vessel, the casing including electrical feedthroughs delivering electrical power to the hydraulic pump.

5. A method comprising:
providing a pressurized water reactor (PWR) comprising a pressure vessel containing a nuclear core comprising a fissile material immersed in primary coolant water;
pumping primary coolant using an electrically driven hydraulic pump to generate first primary coolant flow; and
transforming the first primary coolant flow into second primary coolant flow circulating inside the pressure vessel, the second primary coolant flow having lower pressure and higher volume than the first primary coolant flow.

6. The method of claim 5, wherein the transforming comprises:
driving a hydraulically driven pump using the first primary coolant flow.

7. The method of claim 6, wherein the driving comprises:
driving a turbine of a turbo pump using the first primary coolant flow to rotate an impeller of the turbo pump to generate the second primary coolant flow.

8. The method of claim 7, wherein the driving comprises:
discharging the first primary coolant flow from the turbine so as to additively combine with the second primary coolant flow circulating inside the pressure vessel.

9. The method of claim 6, further comprising:
discharging the first primary coolant flow from the hydraulically driven pump so as to additively combine with the second primary coolant flow circulating inside the pressure vessel.

10. An apparatus comprising:
a pressurized water reactor (PWR) comprising a pressure vessel containing a nuclear core comprising a fissile material immersed in primary coolant water; and
a reactor coolant pump configured to pump primary coolant water in the pressure vessel, the reactor coolant pump comprising a hydraulically driven turbo pump disposed in the pressure vessel.

11. The apparatus of claim 10, wherein the turbo pump comprises:
an impeller performing pumping of primary coolant water in the pressure vessel; and
a hydraulically driven turbine mechanically coupled with the impeller to drive the impeller.

12. The apparatus of claim 11, wherein the reactor coolant pump further comprises:
a hydraulic pump configured pump primary coolant water to generate hydraulic working fluid that drives the hydraulically driven turbine.

13. The apparatus of claim 12, wherein the hydraulic pump is connected with an inlet of the turbine to input the hydraulic working fluid to the turbine but the hydraulic pump is not connected with an outlet of the turbine.

14. The apparatus of claim 12, wherein the turbine includes an outlet discharging the hydraulic working fluid into the pressure vessel to recombine with the primary coolant water in the pressure vessel.

15. The apparatus of claim 14, wherein the outlet of the turbine is arranged so that discharge of the hydraulic working fluid from the turbine additively contributes to the pumping of primary coolant water in the pressure vessel performed by the impeller.

16. The apparatus of claim 14, wherein:
the turbine of the turbo pump is arranged downstream of the impeller of the turbo pump respective to the flow of pumped primary coolant water such that primary coolant water discharged by the impeller flows over the turbine; and
the outlet of the turbine is arranged at the downstream end of the turbine.

17. The apparatus of claim 12, wherein the hydraulic pump is an electrically driven hydraulic pump having a casing defining a portion of the pressure boundary of the pressure vessel, the casing including electrical feedthroughs delivering electrical power to the hydraulic pump.

18. The apparatus of claim 11, wherein the turbine includes a rotor mounted on a rotating shaft and the impeller is mounted on the same rotating shaft.

19. The apparatus of claim 11, wherein:
the turbine includes a rotor, and
the impeller and the rotor of the turbine define a unitary rotating element.

20. The apparatus of claim 11, further comprising:
an inlet hydraulic line passing through the pressure vessel and delivering hydraulic working fluid from outside the pressure vessel into the turbine; and
an outlet hydraulic line passing through the pressure vessel and discharging the hydraulic working fluid from the turbine.

21. The apparatus of claim 20, wherein the hydraulic working fluid is in fluid isolation from the primary coolant water.

22. The apparatus of claim 10, wherein the pressure vessel of the PWR is a vertically oriented cylindrical pressure vessel and PWR further includes a cylindrical central riser disposed concentrically within the cylindrical pressure vessel, an annular downcomer region being defined between the cylindrical central riser and the cylindrical pressure vessel;
wherein the reactor coolant pump is arranged to pump primary coolant water in the pressure vessel along a flow circuit in which the primary coolant water ascends inside the central riser and descends in the downcomer region.

23. The apparatus of claim 22, wherein the hydraulically driven turbo pump is disposed in the downcomer region of the pressure vessel and the apparatus further comprises an annular plate disposed in the downcomer region, the turbo pump being mounted at an opening of the annular plate.

24. The apparatus of claim 22, wherein the hydraulically driven turbo pump is disposed in the cylindrical central riser.

25. The apparatus of claim 22 wherein the hydraulically driven turbo pump is disposed between a baffle plate and a fluidic entrance to a internal steam generator.
